(19) United States
(12) Patent Application Publication
(10) Pub. No.: US 2010/0177842 A1
(43) Pub. Date: Jul. 15, 2010

(54) CODEWORD GENERATION METHOD AND DATA TRANSMISSION METHOD USING THE SAME

(76) Inventors: Jae Won Chang, Anyang-si (KR); Bin Chul Ihm, Anyang-si (KR); Jin Young Chun, Anyang-si (KR); Moon Il Lee, Anyang-si (KR); Wook Bong Lee, Anyang-si (KR)

Correspondence Address: BIRCH STEWART KOLASCH & BIRCH, PO BOX 747, FALLS CHURCH, VA, 22040-0747, US

(21) Appl. No.: 12/440,419

(22) PCT Filed: Oct. 18, 2007
(86) PCT No.: PCT/KR2007/005105

§ 371 Date: Mar. 6, 2009

(30) Foreign Application Priority Data
Oct. 19, 2006 (US) 60862157
Feb. 14, 2007 (KR) 1020070015550

(51) Int. Cl. H04L 27/28

(52) U.S. Cl. 375/295

(57) ABSTRACT

A data transmission method includes encoding information bits to generate a codeword including a plurality of data symbols, the sum of the plurality of data symbols of the codeword being equal to zero, multiplexing a data symbol and a pilot with a subcarrier and transmitting multiplexed data symbol and pilot through the subcarrier. Since a data symbol and a pilot are multiplexed together to a subcarrier, channel estimation performance can be improved.

### TECHNICAL FIELD

The present invention relates to wireless communication, and more particularly, to a data transmission method of transmitting data and pilots together in a wireless communication system.

### BACKGROUND ART

Orthogonal Frequency Division Multiplexing (OFDM) is one of multi-carrier transmission/modulation methods. The OFDM can differently allocate the number of subcarriers according to data rate required by a user to efficiently distribute radio resources. Furthermore, the user is not required to perform initialization using a preamble before receiving data, and thus transmission efficiency can be improved. The OFDM can efficiently be applied to a wireless communication system which has large coverage and delay spread is relatively large. Frequency-hopping OFDM can improve frequency diversity and obtain interference averaging effect even though fading or subcarrier interference exists in a channel.

A receiver estimates a channel in order to reproduce data transmitted from a transmitter. Channel estimation refers to a process that compensates for signal distortion caused by abrupt environment variation due to fading. In coherent detection, channel estimation is performed using a pilot. The pilot is data known to both the receiver and the transmitter.

The accuracy of channel estimation depends on the difference between a estimated channel of the pilot and a real channel of the data. As the number of the pilot increases, the accuracy of channel estimation can improve. However, an increase of the number of the pilot requires more radio resources for the pilot.

As the pilot approaches the data in time domain and/or frequency domain, the difference between the estimated channel of the pilot and the real channel of the data can be reduced. Channel estimation performance can be improved by arranging the pilot in proximity to the data on the time domain and/or the frequency domain.

There is a need for a method of efficiently arranging the pilot to effectively use radio resources and to improve performance of the channel estimation.

### DISCLOSURE OF INVENTION

### Technical Problem

One object of the present invention is to provide a data transmitting method of transmitting data and pilot signals together to efficiently use radio resources.

Another object of the present invention is to provide a data transmitting method for arranging a pilot signal in close proximity to data to improve channel estimation performance.

### Technical Solution

In one aspect, there is provided a data transmission method in a wireless communication. The data transmission method includes encoding information bits to generate a codeword including a plurality of data symbols, the sum of the plurality of data symbols of the codeword being equal to zero, multiplexing a data symbol and a pilot with a subcarrier and transmitting multiplexed data symbol and pilot through the subcarrier.

In another aspect, there is provided a method for transmitting a control signal. The control signal mapped to a codeword. The method includes generating a basic codeword including a plurality of first data symbols, generating an extension codeword including a plurality of second data symbols having signs opposite to signs of the first data symbols, generating the codeword by respectively combining pilots with the basic codeword and the extension codeword and transmitting the codeword.

In still another aspect, there is provided a method for generating a codeword. The method includes generating a basic codeword, generating an extension codeword so that the sum of the basic codeword and the extension codeword becomes zero and generating the codeword by combining the basic codeword and the extension codeword.

### Advantageous Effects

Since a data symbol and a pilot are multiplexed together to a subcarrier and a channel can be estimated using a pilot along with a data symbol, channel estimation performance can be improved. In addition, since there is no need to allocate a subcarrier only for the pilot, radio resources can be effectively used.

### BRIEF DESCRIPTION OF THE DRAWINGS

FIG. 1 is a block diagram of a wireless communication system.

FIG. 2 illustrates one example of pilot allocation.

FIG. 3 illustrates another example of pilot allocation.

FIG. 4 illustrates arrangement of data symbols and pilots according to one embodiment of the present invention.

FIG. 5 illustrates arrangement of data symbols and pilots in a data transmission method according to an embodiment of the present invention.

FIG. 6 illustrates an example of mapping information bits to a codeword.

FIG. 7 illustrates another example of mapping information bits to a codeword.

FIG. 8 illustrates still another example of mapping information bits to a codeword

FIG. 9 illustrates a method of generating twelve data symbols for five information bits according to an embodiment of the present invention.

FIG. 10 illustrates one example of mapping five information bits to a codeword.

FIG. 11 illustrates another example of mapping five information bits to a codeword.

FIG. 12 illustrates one example of mapping five information bits to a codeword.

### MODE FOR THE INVENTION

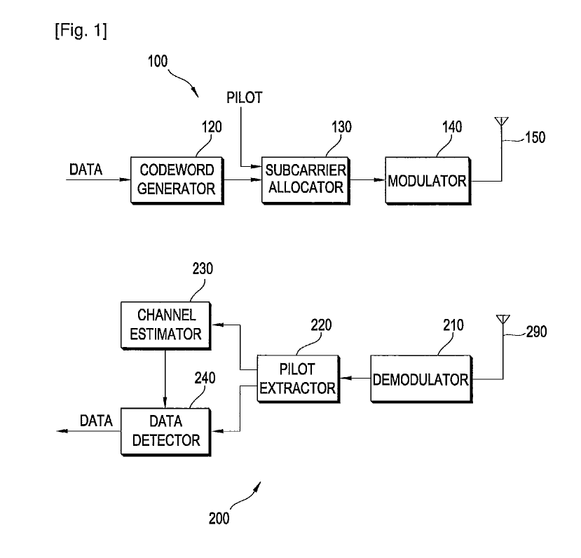

FIG. 1 is a block diagram of a wireless communication system.

Referring to FIG. 1, a transmitter 100 includes a codeword generator 120, a subcarrier allocator 130, and a modulator 140.

The codeword generator 120 encodes an input data stream according to a predetermined coding method to generate a codeword. A method for generating the codeword will be described later.

The subcarrier allocator 130 allocates the codeword and a pilot to appropriate subcarriers. The codeword includes N data symbols, where N is an integer.

The modulator 140 performs inverse fast Fourier transform (IFFT) on the output of the subcarrier allocator 130. A OFDM symbol is an output of the modulator 140. The OFDM symbol is transmitted through a transmit antenna 150.

A receiver 200 includes a demodulator 210, a pilot extractor 220, a channel estimator 230 and a data detector 240. The demodulator 210 performs fast Fourier transform (FFT) on a received signal through a receive antenna 290. The pilot extractor 220 splits a demodulated signal into a data symbol and a plot. The channel estimator 230 estimates a channel using the pilot. The data detector 240 decodes the data symbol to reproduce original data.

Since the transmitter 100 has a single transmit antenna and the receiver 200 has a single receive antenna, the wireless communication system is a signal-input single-output (SISO) system. The present inventive concept can be also applied to a multi-input multi-output (MIMO) system having multiple transmit antennas and multiple receive antennas. Furthermore, while the transmitter 100 and the receiver 200 employ Orthogonal Frequency Division Multiplexing (OFDM)/Orthogonal Frequency Division Multiple Access (OFDMA), the present inventive concept can be applied to time division multiple access (TDMA), code division multiple access (CDMA) and other multiple access schemes.

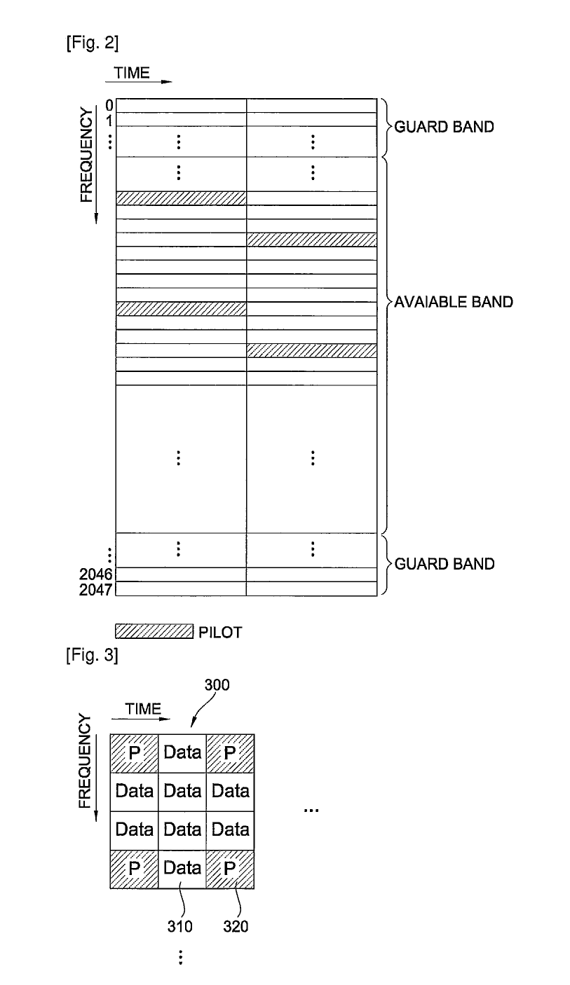

FIG. 2 illustrates one example of pilot allocation. In an OFDM/OFDMA system, a plurality of subcarriers is used to transmit data. Both sides of full bandwidth are used as guard bands, and a pilot is allocated to a subcarrier in an available band.

Referring to FIG. 2, the OFDM/OFDMA system uses 2048 subcarriers. 7 Data symbols are allocated to 7 consecutive subcarriers over the available band and pilots are allocated at the interval of 8 subcarriers. A receiver estimates a channel using the pilots. The channel is estimated using the pilots allocated to every 8 subcarriers and the data symbols are reproduced using the estimated channel.

When the pilots and data symbols are arranged in close proximity to each other, the estimated channel of the pilots becomes close to a real channel of the data symbols. Accordingly, a method for allocating pilots in close proximity to data symbols is needed.

FIG. 3 illustrates another example of pilot allocation.

Referring to FIG. 3, data is transmitted through a tile 300 comprising twelve subcarriers. The tile 300 includes three OFDM symbols each having four subcarriers. Pilots are respectively allocated to four subcarriers 320 at the corners of the tile 300 and data symbols are respectively allocated to the remaining subcarriers 310.

The data symbols and the pilots are respectively allocated to different subcarriers. Channel estimation is performed on the assumption that a channel through which the pilots pass is almost identical to a channel through which the data symbols pass. However, in the real environment the channel of the pilots is not identical to the channel of the data symbols since data symbols and the pilots are not transmitted through same subcarriers.

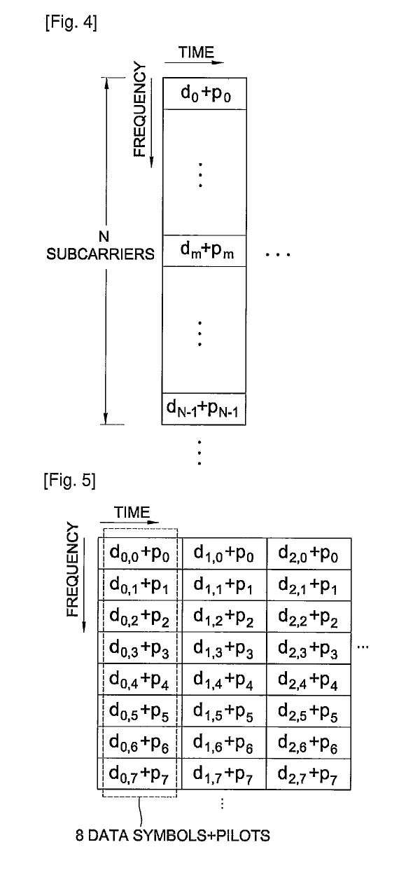

FIG. 4 illustrates arrangement of data symbols and pilots according to one embodiment of the present invention.

Referring to FIG. 4, a pilot Pₘ and a data symbol dₘ is multiplexed to a single subcarrier. Since the pilot and the data symbol are transmitted simultaneously, radio resources can be efficiently used.

When there are N subcarriers, a received signal xₘ at a receiver is represented as follows:

MathFigure 1

xₘ=h(dₘ+pₘ)+vₘ [Math.1]

where dₘ is a data symbol allocated to a m-th subcarrier, pₘ is a pilot signal allocated to a m-th subcarrier, h is a channel and vₘ is a noise.

N received signal through N subcarriers can be summed up. When the sum of the data symbols allocated to the N subcarriers corresponds to zero, the N received signals are represented as follows:

$$\begin{matrix}MathFigure 2 & \\ \begin{matrix}\frac{1}{N} {\sum }_{m = 0}^{N - 1} {x}_{m} = \frac{1}{N} {\sum }_{m = 0}^{N - 1} h ( {d}_{m} + {p}_{m} ) + {v}_{m} \\ = \frac{1}{N} {\sum }_{m = 0}^{N - 1} h {p}_{m}\end{matrix} & [ Math . 2 ]\end{matrix}$$

It is assumed that a channel is not changed or has an ignorable variation for the N subcarriers and noise is ignorable or the sum of noises is zero for the N subcarriers.

An estimated channel h can be obtained as follows:

$$\begin{matrix}MathFigure 3 & \\ \underline{h} = \frac{1}{N} {\sum }_{m = 0}^{N - 1} {p}_{m}^{*} {x}_{m} & [ Math . 3 ]\end{matrix}$$

Where p*ₘ is a conjugate complex with respect to the pilot signal pₘ, which satisfies pₘp*ₘ=1.

After obtaining the estimated channel h, transmitted data can be reproduces using the channel estimation value h. A estimated data symbol dₘ can be obtained as follows:

$$\begin{matrix}MathFigure 4 & \\ \frac{{x}_{m}}{\underline{h}} = \frac{h ( {d}_{m} + {p}_{m} )}{\underline{h}} + \frac{{v}_{m}}{\underline{h}} ≃ {d}_{m} + {p}_{m} + \overline{{v}_{m}} , \\ \underline{{d}_{m}} = decision ( \frac{{x}_{m}}{\underline{h}} - {p}_{m} ) & [ Math . 4 ]\end{matrix}$$

where decision( ) denotes any criteria to determine the estimated data symbol dₘ using xₘ/h and pₘ.

The receiver can obtain the estimated data symbol dₘ allocated to m-th subcarrier using the received signal xₘ, the pilot pₘ and the estimated channel h.

A codeword generator generates a codeword comprising N data symbols. The sum of the data symbols in the codeword is zero. N data symbols d₀, . . . , d_{N-1} satisfy following condition.

$$\begin{matrix}MathFigure 5 & \\ {\sum }_{m = 0}^{N - 1} {d}_{m} = 0 & [ Math . 5 ]\end{matrix}$$

The codeword generator can generate the codeword using various methods. The codeword can be divided by two parts, a basic codeword and an extension codeword. The basic codeword means data symbols generated by using conventional channel coding. The basic codeword can be generated by various methods such as block type channel coding and trellis type channel coding. To make the sum of data symbols of the codeword zero, the extension codeword is added to the basic codeword. The extension codeword is composed of data symbols that make the sum of the data symbols of the codeword become zero when the extension codeword is added to the basic codeword. The codeword is composed of data symbols for the basic codeword and data symbols for the extension codeword. For example, if the basic codeword is (1, 1, 1, 1), the extension codeword can be (−1, −1, −1, −1). The codeword includes eight symbols, (1, 1, 1, 1, −1, −1, −1, −1).

Various examples of generating a codeword will be described below.

To generate a basic codeword, it is possible to use various methods such a discrete Fourier Transform (DET) matrix, a simplex code, a Walsh Hadamard matrix and an orthogonal matrix.

The basic codeword can be generated by using one of rows (or columns) of an orthogonal matrix as a mapping vector and mapping the mapping vector to at least one information bit. The orthogonal matrix is a matrix having two different row vectors or column vectors which are orthogonal. The mapping vector means a single row (or column) vector in the orthogonal matrix or a simplex code.

To make the sum of the data symbols of the codeword zero, an extension codeword is added to the basic codeword. The extension codeword can be composed of a negative mapping vector (−C) obtained by giving a negative sign to each data symbol of the mapping vector C.

A DFT matrix is an N×N matrix having six entries w^{mn} as shown:

MathFigure 6

w^{mn}=e^{-j2πmn/N} [Math.6]

where m,n=0, 1, . . . , (N−1).

The DFT matrix having N mapping vectors is represented as shown:

$$\begin{matrix}MathFigure 7 & \\ W = [ \begin{matrix}{C}_{0} \\ {C}_{1} \\ ⋮ \\ {C}_{n - 1}\end{matrix} ] \\ = [ \begin{matrix}{e}^{- j2π \cdot 0 \cdot 0 / N} & {e}^{- j2π \cdot 0 \cdot 1 / N} & … & {e}^{- j2π \cdot 0 \cdot ( N - 1 ) / N} \\ {e}^{- 2 π \cdot 1 \cdot 0 / N} & {e}^{- j2π \cdot 1 \cdot 1 / N} & … & {e}^{- j2π \cdot 1 \cdot ( N - 1 ) / N} \\ ⋮ & ⋮ & & ⋮ \\ {e}^{- 2 π \cdot ( N - 1 ) \cdot 0 / N} & {e}^{- 2 π \cdot ( N - 1 ) \cdot 1 / N} & … & {e}^{- 2 π \cdot ( N - 1 ) \cdot ( N - 1 ) / N}\end{matrix} ] & [ Math . 7 ]\end{matrix}$$

For example, a 2×2 DFT matrix including two mapping vectors is represented as below.

$$\begin{matrix}MathFigure 8 & \\ {W}_{2} = [ \begin{matrix}{C}_{0 } \\ {C}_{1}\end{matrix} ] = [ \begin{matrix}1 & 1 \\ 1 & {e}^{- j2π / 2}\end{matrix} ] = [ \begin{matrix}1 & 1 \\ 1 & - 1\end{matrix} ] & [ Math . 8 ]\end{matrix}$$

A 4×4 DFT matrix including four mapping vectors is represented as below.

$$\begin{matrix}MathFigure 9 & \\ {W}_{4} = [ \begin{matrix}{C}_{0} \\ {C}_{1} \\ {C}_{2} \\ {C}_{3}\end{matrix} ] \\ = [ \begin{matrix}1 & 1 & 1 & 1 \\ 1 & {e}^{- jπ / 2} & {e}^{- jπ} & {e}^{- j3π / 2} \\ 1 & {e}^{- jπ} & {e}^{- j2π} & {e}^{- j3π} \\ 1 & {e}^{- j3π / 2} & {e}^{- j3π} & {e}^{- j9π / 2}\end{matrix} ] \\ = [ \begin{matrix}1 & 1 & 1 & 1 \\ 1 & - j & - 1 & j \\ 1 & - 1 & 1 & - 1 \\ 1 & j & - 1 & - j\end{matrix} ] & [ Math . 9 ]\end{matrix}$$

Walsh code can be used as an orthogonal matrix. A 4×4 matrix using Walsh-Hadamard matrix includes four mapping vectors as represented by

$$\begin{matrix}MathFigure 10 & \\ {W}^{walsh} = [ \begin{matrix}{C}_{0} \\ {C}_{1} \\ {C}_{2} \\ {C}_{3}\end{matrix} ] = [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ] & [ Math . 10 ]\end{matrix}$$

An orthogonal matrix is not limited to the aforementioned examples and can be obtained through various methods. A Mapping vector can be obtained by extracting a row vector or a column vector of the orthogonal matrix.

A simplex code can be generated by removing the first column of an orthogonal matrix. In the case of DFT matrix, the simplex code can be represented as shown:

$$\begin{matrix}MathFigure 11 & \\ S = [ \begin{matrix}{C}_{0} \\ {C}_{1} \\ ⋮ \\ {C}_{n - 1}\end{matrix} ] \\ = [ \begin{matrix}{e}^{- j2π \cdot 0 \cdot 1 / N} & {e}^{- j2π \cdot 0 \cdot 2 / N} & … & {e}^{- j2π \cdot 0 \cdot ( N - 1 ) / N} \\ {e}^{- 2 π \cdot 1 \cdot 1 / N} & {e}^{- j2π \cdot 1 \cdot 2 / N} & … & {e}^{- j2π \cdot 1 \cdot ( N - 1 ) / N} \\ ⋮ & ⋮ & & ⋮ \\ {e}^{- 2 π \cdot ( N - 1 ) \cdot 1 / N} & {e}^{- 2 π \cdot ( N - 1 ) \cdot 2 / N} & … & {e}^{- 2 π \cdot ( N - 1 ) \cdot ( N - 1 ) / N}\end{matrix} ] & [ Math . 11 ]\end{matrix}$$

For example, a 2×1 simplex code can be represented as shown:

$$\begin{matrix}MathFigure 12 & \\ {W}_{2} = [ \begin{matrix}{C}_{0} \\ {C}_{1}\end{matrix} ] = [ \begin{matrix}1 \\ {e}^{- j2π / 2}\end{matrix} ] = [ \begin{matrix}1 \\ - 1\end{matrix} ] & [ Math . 12 ]\end{matrix}$$

A 4×3 simplex code can be represented as shown:

$$\begin{matrix}MathFigure 13 & \\ {W}_{4} = [ \begin{matrix}{C}_{0} \\ {C}_{1} \\ {C}_{2} \\ {C}_{3}\end{matrix} ] \\ = [ \begin{matrix}1 & 1 & 1 \\ {e}^{- jπ / 2} & {e}^{- jπ} & {e}^{- j3π / 2} \\ {e}^{- jπ} & {e}^{- j2π} & {e}^{- j3π} \\ {e}^{- j3π / 2} & {e}^{- j3π} & {e}^{- j9π / 2}\end{matrix} ] \\ = [ \begin{matrix}1 & 1 & 1 \\ - j & - 1 & j \\ - 1 & 1 & - 1 \\ j & - 1 & - j\end{matrix} ] & [ Math . 13 ]\end{matrix}$$

In this manner, a matrix having a plurality of mapping vectors can be generated. While a mapping vector is obtained from a row vector of an orthogonal matrix or a simplex code in the above-described examples, the mapping vector can be obtained from a column vector of the orthogonal matrix or simplex code.

The mapping vector obtained as described is mapped to information bits to generate a basic codeword. An extension codeword is added to the basic codeword such that the sum of data symbols of the codeword comprising the basic codeword and the extension codeword becomes zero.

The basic codeword is generated by combining at least one mapping vector and the length or the number of date symbols of the codeword can be adjusted by combining mapping vectors in various manners.

In one embodiment, a basic codeword CW can be generated by repeating a mapping vector as shown:

$$\begin{matrix}MathFigure 14 & \\ CW = [ {C}_{i} {C}_{i} {C}_{i} … {C}_{i} ] , i = 0 , … , N - 1 & [ Math . 14 ]\end{matrix}$$

N basic codewords can be obtained. An extension codeword NW is generated by giving a negative sign to each mapping vector as shown:

$$\begin{matrix}MathFigure 15 & \\ NW = [ - {C}_{i} - {C}_{i} - {C}_{i} … - {C}_{i} ] , i = 0 , … , N - 1 & [ Math . 15 ]\end{matrix}$$

In another embodiment, a basic codeword can be generated by repeating a mapping vector twice as shown:

$$\begin{matrix}MathFigure 16 & \\ {CW}^{0} = [ {C}_{0} {C}_{0} {C}_{i} {C}_{i} {C}_{0} {C}_{0} {C}_{i} {C}_{i} … ] , \\ i = 0 , … , N - 1 , i \neq 0 \\ {CW}^{1} = [ {C}_{1} {C}_{1} {C}_{i} {C}_{i} {C}_{1} {C}_{1} {C}_{i} {C}_{i} … ] , \\ i = 0 , … , N - 1 , i \neq 1 \\ ⋮ \\ {CW}^{N - 1} = [ {C}_{N - 1} {C}_{N - 1} {C}_{i} {C}_{i} {C}_{N - 1} {C}_{N - 1} … ] , \\ i = 0 , … , N - 1 , i \neq N - 1 & [ Math . 16 ]\end{matrix}$$

N(N−1) basic codewords can be obtained.

In another embodiment, a basic codeword can be generated by alternately arranging two different mapping vectors as shown:

$$\begin{matrix}MathFigure 17 & \\ {CW}^{0} = [ {C}_{0} {C}_{i} {C}_{0} {C}_{i} {C}_{0} {C}_{i} … ] , \\ i = 0 , … , N - 1 , i \neq 0 \\ {CW}^{1} = [ {C}_{1} {C}_{i} {C}_{1} {C}_{i} {C}_{1} {C}_{i} … ] , \\ i = 0 , … , N - 1 , i \neq 1 \\ ⋮ \\ {CW}^{N - 1} = [ {C}_{N - 1} {C}_{i} {C}_{N - 1} {C}_{i} … ] , \\ i = 0 , … , N - 1 , i \neq N - 1 & [ Math . 17 ]\end{matrix}$$

N(N−1) basic codewords can be obtained.

In still another embodiment, a basic codeword can be generated by arranging a mapping vector and repeating another mapping vector twice after the mapping vector as shown:

$$\begin{matrix}MathFigure 18 & \\ {CW}^{0} = [ {C}_{0} {C}_{i} {C}_{i} {C}_{0} {C}_{i} {C}_{i} … ] , \\ i = 0 , … , N - 1 , i \neq 0 \\ {CW}^{1} = [ {C}_{1} {C}_{i} {C}_{i} {C}_{1} {C}_{i} {C}_{i} … ] , \\ i = 0 , … , N - 1 , i \neq 1 \\ ⋮ \\ {CW}^{N - 1} = [ {C}_{N - 1} {C}_{i} {C}_{N - 1} {C}_{i} … ] , \\ i = 0 , … , N - 1 , i \neq N - 1 & [ Math . 18 ]\end{matrix}$$

N(N−1) basic codewords can be obtained.

In still another embodiment, a basic codeword can be generated by sequentially increasing or decreasing the index of a mapping vector a shown:

$$\begin{matrix}MathFigure 19 & \\ {CW}^{0} = [ \begin{matrix}{C}_{( 0 + i ) modN} {C}_{( i + i ) modN} \\ {C}_{( 2 + i ) modN} … {C}_{( N - 1 + i ) modN}\end{matrix} ] , \\ i = 0 , … , N - 1 \\ {CW}^{1} = [ \begin{matrix}{C}_{( 0 + i ) modN} {C}_{( 2 + i ) modN} \\ {C}_{( 1 + i ) modN} … {C}_{( N - 1 + i ) modN}\end{matrix} ] , \\ i = 0 , … , N - 1 \\ {CW}^{2} = [ \begin{matrix}{C}_{( 0 + i ) modN} {C}_{( 2 + i ) modN} \\ {C}_{( 3 + i ) modN} … {C}_{( N - 1 + i ) modN}\end{matrix} ] , \\ i = 0 , … , N - 1 \\ {CW}^{3} = [ \begin{matrix}{C}_{( 0 + i ) modN} {C}_{( 2 + i ) modN} \\ {C}_{( 4 + i ) modN} … {C}_{( N - 1 + i ) modN}\end{matrix} ] , \\ i = 0 , … , N - 1 \\ ⋮ \\ {CW}^{r} = [ \begin{matrix}{C}_{( 0 + i ) modN} {C}_{( N - 1 + i ) modN} \\ {C}_{( N - 2 + i ) modN} … {C}_{( 1 + i ) modN}\end{matrix} ] , \\ i = 0 , … , N - 1 & [ Math . 19 ]\end{matrix}$$

N(N−1)! basic codewords can be obtained.

In still another embodiment, a phases of a data symbol can be rotated as shown

$$\begin{matrix}MathFigure 20 & \\ {R}^{rot} = {e}^{b θ} {R}^{s} & [ Math . 20 ]\end{matrix}$$

where R^{s} represents a mapping vector obtained above methods, θ is a phase rotation value and b is an integer greater than 1. When a mapping vector size is K (that is, a mapping vector includes K symbols), b=1, 2, . . . , K−1. θ and/or b can be values previously known to the transmitter and the receiver. Otherwise, the transmitter can inform the receiver of the θ and/or b.

FIG. 5 illustrates arrangement of data symbols and pilots in a data transmission method according to an embodiment of the present invention.

Referring to FIG. 5, data symbols and pilots are multiplexed for 8 subcarriers in an OFDM symbol. Transmit powers for each pilot is respectively distributed over the eight subcarriers.

8 data symbols which form a codeword satisfy following condition

$$\begin{matrix}MathFigure 21 & \\ {\sum }_{m = 0}^{7} {d}_{k , m} = 0 & [ Math . 21 ]\end{matrix}$$

where k is an index of an OFDM symbol and m is an index of a subcarrier.

A receiver previously knows a pilot pₘ and can perform channel estimation. A data symbol d_{k.m} can be detected using an estimated channel.

The 8 data symbols can be combined in various manners to satisfy the above condition. The 8 data symbols can construct a basic codeword and an extension codeword. For example, five data symbols construct the basic codeword and the remaining three data symbols forms the extension codeword.

It is assumed that four data symbols construct the basic codeword and the other four data symbols construct the extension codeword. Data symbols d_{0.0}, d_{0.1}, d_{0.2} and d_{0.3} in FIG. 5 can construct the basic codeword and data symbols d_{0.4}, d_{0.5}, d_{0.6} and d_{0.7} can construct the extension codeword. In this case, the data symbols of the extension codeword, d_{0.4}, d_{0.5}, d_{0.6} and d_{0.7}, can be negative data symbols −d_{0.0}, −d_{0.1}, −d_{0.2} and −d_{0.3} of the basic codeword. The eight data symbols are multiplexed with pilots and allocated to the eight subcarriers. That is, d_{0.0}+p₀, d_{0.1}+p₁, d_{0.2}+p₂, d_{0.3}+p₃, d_{0.4}p₄, d_{0.5}+p₅, d_{0.6}+p₆ and d_{0.7}+p₇ can be respectively allocated to the eight subcarriers and transmitted.

The data symbols of the basic codeword and the data symbols of the extension codeword can be arranged in various manners. For example, the data symbols of the basic codeword and the data symbols of the extension codeword can be alternately arranged such as d_{0.0}, d_{0.4}, d_{0.1}, d_{0.5}, d_{0.2}, d_{0.6}, d_{0.3} and d_{0.7}. Accordingly, d_{0.0}+p₀, d_{0.4}+p₁, d_{0.1}+p₂, d_{0.5}+p₃, d_{0.2}+p₄, d_{0.5}+p₅, d_{0.3}+p₆ and d_{0.7}+p₇ can be respectively allocated to the eight subcarriers and transmitted.

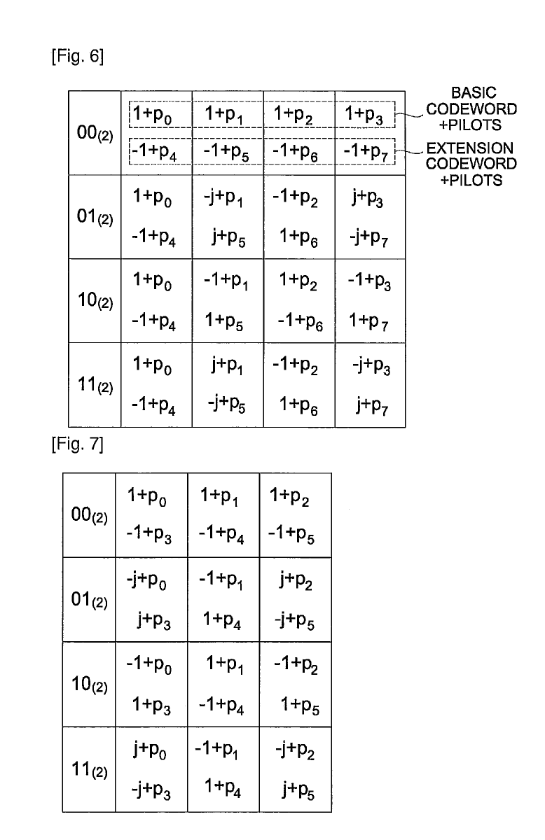

FIG. 6 illustrates an example of mapping information bits to a codeword.

Referring to FIG. 6, 2-bit information bits is mapped to a codeword. 2-bit information bit may be a control signal. The control signal may be a channel quality information (CQI), acknowledgement (ACK)/negative-acknowledgement (NACK) signal, multiple input multiple output (MIMO) codebook index, etc.

The codeword comprises a basic codeword and a extension codeword. A mapping vector comprising 3 data symbols is used for the base codeword. To make the sum of data symbols of the codeword become zero, the extension codeword is added to the basic codeword. The negative mapping vector is used for the extension codeword.

The codeword for the 2-bit control signal is composed of eight data symbols. The data symbols and the pilots are multiplexed to eight subcarriers.

The mapping vector C₀ for a control signal 00₍₂₎ includes four data symbols, (1, 1, 1, 1). Here, 00₍₂₎ represents a binary number. To make the sum of data symbols of the codeword become zero, a negative mapping vector −C₀ o is added to the mapping vector C₀ to form the codeword. Consequently, the codeword includes eight data symbols, (1, 1, 1, 1, −1, −1, −1, −1). Pilots are respectively multiplexed to the eight data symbols. Accordingly, 1+p₀, 1+p₁, 1+p₂, 1+p₃, −1+p₄, −1+p₅, −1+p₆ and −1+p₇ are respectively allocated to the eight subcarriers and transmitted.

A mapping vector C₁ for a control signal 01₍₂₎ includes four data symbols (1, −j, −1, 1). A negative mapping vector −C₁ having data symbols (−1, j, 1, −j) can be generated by giving a negative sign to the data symbols (1, −j, −1, 1) of the mapping vector C₁. The mapping vector C₁ can be added to the negative mapping vector −C₁ to generate a codeword having eight data symbols (1, −j, −1, 1, −1, j, 1, −j). Pilots are respectively multiplexed to the eight data symbols of the codeword and allocated to eight subcarriers. 1+p₀, −j+p₁, −1+p₂, j+p₃, −1+p₄, j+p₅, 1+p₆ and −j+p₇ are respectively allocated to the eight subcarriers.

A mapping vector C₂ for a control signal 10₍₂₎ includes four data symbols (1, −1, 1, −1). A negative mapping vector −C₂ includes data symbols (−1, 1, −1, 1). Accordingly, a codeword including eight data symbols composed of the mapping vector C₂ and the negative mapping vector −C₂ can be generated. Pilots are respectively multiplexed to the eight data symbols of the codeword and allocated to eight subcarriers. 1+p₀, −1+p₁, 1+p₂, −1+p₃, −1+p₄, 1+p₅, −1+p6 and −1+p₇ are respectively mapped to the eight subcarriers.

Pilots are respectively multiplexed to the eight data symbols of a codeword for a control signal 11₍₂₎. The pilots are respectively added to data symbols of a mapping vector C₃ and a negative mapping vector −C₃ and allocated to eight subcarriers. 1+p₀, j+p₁, −1+p₂, −j+p₃, −1+p₄, −j+p₅, 1+p₆ and j+p₇ can be respectively allocated to the eight subcarriers.

FIG. 7 illustrates another example of mapping information bits to a codeword.

Referring to FIG. 7, a codeword can be generated for a 2-bit control signal using the four mapping vectors (C₀, C₁, C₂, C₃) of the 4×3 simplex code of Equation 13.

For a control signal 00₍₂₎, a mapping vector C₀ includes three data symbols (1, 1, 1) and a negative mapping vector −C₀ includes three data symbols (−1, −1, −1). The mapping vector C₀ and the negative mapping vector −C₀ are combined to generate a codeword composed of six data symbols. To make the sum of the six data symbols of the codeword zero, pilots are respectively added to the six data symbols and allocated to six subcarriers. 1+p₀, 1+p₁, 1+p₂, −1+p₃, −1+p₄ and −1+p₅ can be respectively allocated to the six subcarriers and transmitted.

For a control signal 01₍₂₎, a basic codeword (−j, −1, j) and an extension codeword (j, 1, −1) are used. Pilots are respectively added to the six data symbols and allocated to six subcarriers. Accordingly, −j+p0, −1+p₁, j+p₂, j+p₃, 1+p₄, −j+p₅ can be respectively allocated to the six subcarriers.

For a control signal 10₍₂₎, pilots are respectively added to a basic codeword (−1, 1, −1) and an extension codeword (1, −1, 1) and allocated to six subcarriers. Accordingly, 1+p₀, 1+p₁, −1+p₂, 1+p₃, −1+p₄ and j+p₅ can be respectively allocated to the six subcarriers.

For a control signal 11₍₂₎, a codeword composed of six data symbols (j, −1, −j, −j, 1, j) is generated. Pilots are respectively added to the six data symbols (j, −1, −j, −j, 1, j) and allocated to six subcarriers. Accordingly, j+p₀, −1+p₁, −j+p₂, −j+p₃, 1+p₄ and j+p₅ can be respectively allocated to the six subcarriers.

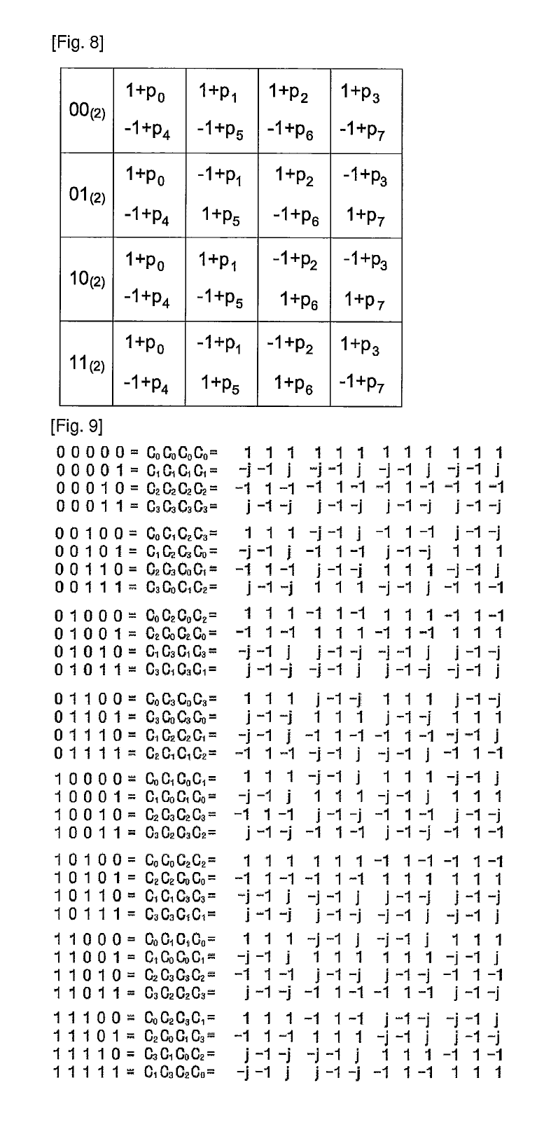

FIG. 8 illustrates still another example of mapping information bits to a codeword.

Referring to FIG. 8, a basic codeword and an extension codeword can be generated for a 2-bit control signal using the four mapping vectors (C₀, C₁, C₂, C₃) of the 4×4 Walsh code.

For a control signal 00₍₂₎, a mapping vector C₀ includes four data symbols (1, 1, 1, 1) and a negative mapping vector −C₀ includes four data symbols (−1, −1, −1, −1). The mapping vector C₀ and the negative mapping vector −C₀ are combined to generate a codeword composed of eight data symbols (1, 1, 1, 1, −1, −1, −1, −1). Pilots are respectively added to the eight data symbols of the codeword and allocated to eight subcarriers. Accordingly, 1+p₀, 1+p₁, 1+p₂, 1+p₃, −1+p₄, −1+p₅, −1+p₆ and −1+p₇ can be respectively allocated to the eight subcarriers and transmitted.

For a control signal 01₍₂₎, pilots are respectively added to eight data symbols and 1+p₀, −1+p₁, 1+p₂, −1+p₃, −1+p₄, 1′p₅, −1+p₆ and 1+p₇ are respectively allocated to the eight subcarriers and transmitted.

For a control signal 10₍₂₎, 1+p₀, 1+p₁, −1+p₂, −1+p₃, −1+p₄, −1+p₅, −1+p₆ and 1+p₇ are respectively allocated to the eight subcarriers and transmitted.

For a control signal 11₍₂₎, 1+p₀, −1+p₁, −1+p₂, 1+p₃, −1+p₄, 1+p₅, 1+p₆ and −1+p₇ are respectively allocated to the eight subcarriers and transmitted.

A codeword having data symbols (the sum of the data symbols equals zero) is generated for a control signal. The data symbols of the codeword are respectively multiplexed with pilots. A receiver which received the data symbols and the pilots estimates channel and reproduce the data symbols. Channel estimation performance is improved since a data symbol and a pilot are multiplexed onto a subcarrier. Radio resources can be efficiently allocated because there is no need to allocate a plurality of subcarriers for the pilot and the data symbol.

FIG. 9 illustrates a method of generating twelve data symbols for five information bits according to an embodiment of the present invention.

Referring to FIG. 9, five information bits are mapped to a codeword using four mapping vectors (C₀, C₁, C₂, C₃) and the codeword includes twelve data symbols. The four mapping vectors (C₀, C₁, C₂, C₃) can correspond to the four mapping vectors of the 4×4 Walsh code.

Five information bits 00100₍₂₎ are mapped to four mapping vector (C₀, C₁, C₂, C₃). A codeword comprising twelve data symbols (1, 1, 1, −j, −1, j, −1, 1, −1, j, −1, −j) is generated.

Five information bits form thirty-two combinations which can be represented by combinations of the four mapping vectors (C₀, C₁, C₂, C₃). The four mapping vectors each of which corresponds to three data symbols generate a basic codeword including twelve data symbols.

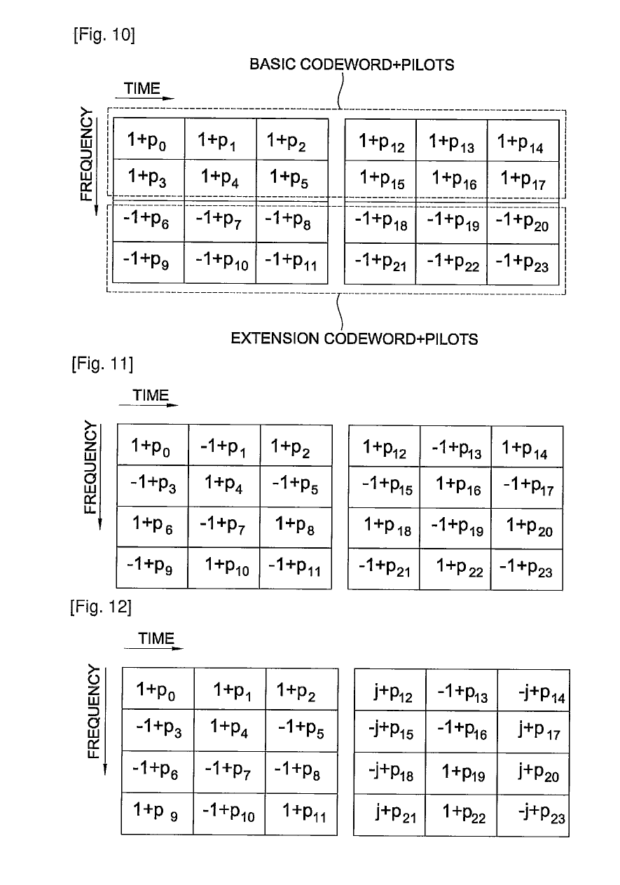

FIG. 10 illustrates one example of mapping five information bits to a codeword.

Referring to FIG. 10, 5-bit control signal is mapped to a codeword and the codeword is transmitted through two tiles. A basic codeword having twelve data symbols is (1, 1, 1, 1, 1, 1, 1, 1, 1, 1, 1, 1). To make the sum of data symbols of the codeword become zero, an extension codeword including negative-sign data symbols (−1, −1, −1, −1, −1, −1, −1, −1, −1, −1, −1, −1) is added to the basic codeword. As a result, the codeword is composed of 24 data symbols.

Pilots are respectively added to the 24 data symbols of the codeword and allocated to the two tiles. The 24 data symbols and the pilots are respectively arranged for twenty-four subcarriers in the two tiles.

Arrangement of the pilots and the codeword in the two tiles are exemplarily shown in FIG. 10. There may be various methods of arranging 24 data symbols and pilots in two tiles.

FIG. 11 illustrates another example of mapping five information bits to a codeword.

Referring to FIG. 11, twelve data symbols and twelve negative-sign data symbols, to which pilots are respectively added, are arranged in two tiles. The twelve data symbols and the pilots respectively added to the data symbols are arranged in one tile and the twelve negative-sign data symbols and the pilots are arranged in the other tile.

FIG. 12 illustrates one example of mapping five information bits to a codeword.

Referring to FIG. 12, 5-bit control signal is mapped to a codeword and the codeword is transmitted through two tiles. A basic codeword includes twelve data symbols (1, 1, 1, −1, 1, −1, j, −1, −j, −j, −1, j) and an extension codeword includes twelve data symbols (−1, −1, −1, 1, −1, 1, −j, 1, j, j, 1, −j). 24 data symbols can be respectively combined with the pilots and arranged in the two tiles.

Since a data symbol and a pilot are multiplexed together to a subcarrier and a channel can be estimated using a pilot along with a data symbol, channel estimation performance can be improved. In addition, since there is no need to allocate a subcarrier only for the pilot, radio resources can be effectively used.

The steps of a method described in connection with the embodiments disclosed herein may be implemented by hardware, software or a combination thereof. The hardware may be implemented by an application specific integrated circuit (ASIC) that is designed to perform the above function, a digital signal processing (DSP), a programmable logic device (PLD), a field programmable gate array (FPGA), a processor, a controller, a microprocessor, the other electronic unit, or a combination thereof. A module for performing the above function may implement the software. The software may be stored in a memory unit and executed by a processor. The memory unit or the processor may employ a variety of means that is well known to those skilled in the art.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims. Therefore, all changes and modifications that fall within the metes and bounds of the claims, or equivalence of such metes and bounds are intended to be embraced by the appended claims.

1. A data transmission method in a wireless communication, the method comprising:
encoding information bits to generate a codeword including a plurality of data symbols, the sum of the plurality of data symbols of the codeword being equal to zero;
multiplexing a data symbol and a pilot with a subcarrier; and
transmitting multiplexed data symbol and pilot through the subcarrier.

2. The method of claim 1, wherein the information bits correspond to a control signal.

3. A method for transmitting a control signal, the control signal mapped to a codeword, the method comprising:
generating a basic codeword including a plurality of first data symbols;
generating an extension codeword including a plurality of second data symbols having signs opposite to signs of the first data symbols;
generating the codeword by respectively combining pilots with the basic codeword and the extension codeword; and
transmitting the codeword.

4. The method of claim 3, wherein the plurality of first data symbols are elements of a mapping vector obtained by extracting a row vector or a column vector of an orthogonal matrix.

5. The method of claim 4, wherein the orthogonal matrix is a discrete Fourier transform (DFT) matrix or Walsh Hadamard matrix.

6. The method of claim 3, wherein the plurality of first data symbols are elements of a mapping vector obtained by extracting a row vector of a simplex code generated by removing a single row or column of an orthogonal matrix.

7. A method for generating a codeword, the method comprising:
generating a basic codeword;
generating an extension codeword so that the sum of the basic codeword and the extension codeword becomes zero; and
generating the codeword by combining the basic codeword and the extension codeword.

8. The method of claim 7, wherein the basic codeword includes a plurality of data symbols and the extension codeword includes a plurality of data symbols having signs opposite to signs of the plurality of data symbols of the basic codeword.
